(19) United States
(12) Patent Application Publication
(10) Pub. No.: US 2026/0312238 A1
(43) Pub. Date: Oct. 8, 2026

(54) BUSBAR

(71) Applicant: TOYOTA JIDOSHA KABUSHIKI KAISHA, Toyota-shi (JP)

(72) Inventors: Koshiro AONO, Toyota-shi (JP); Takayuki SUGIYAMA, Nisshin-shi (JP); Hiroki OHTSUBO, Toyota-shi (JP); Hiroaki IWATA, Toyota-shi (JP); Satoshi TABARA, Miyoshi-shi (JP)

(73) Assignee: TOYOTA JIDOSHA KABUSHIKI KAISHA, Toyota-shi (JP)

(21) Appl. No.: 19/462,007

(22) Filed: Jan. 28, 2026

(30) Foreign Application Priority Data
Feb. 14, 2025 (JP) 2025-022790

(51) Int. Cl. H01M 50/503; H01M 50/507; H01R 25/16

(52) U.S. Cl. CPC H01M 50/503; H01M 50/507; H01R 25/161

(57) ABSTRACT

A busbar has a plate shape and is made of an electrically conductive material. The busbar is configured to be connected to terminals provided on one side of two battery cells arranged in a predetermined direction. The busbar includes: a first connection portion configured to be connected to the terminal of one of the two battery cells; a second connection portion configured to be connected to the terminal of the other battery cell; and a first through hole and a second through hole that are provided in a region between the first and second connection portions and are arranged in an up-down direction. A recessed portion recessed toward the opposite side from the second through hole is provided at an edge of the first through hole that is on the second through hole side.

### CROSS-REFERENCE TO RELATED APPLICATION

This application claims priority to Japanese Patent Application No. 2025-022790 filed on February 14, 2025. The disclosure of the above-identified application, including the specification, drawings, and claims, is incorporated by reference herein in its entirety.

### BACKGROUND

### 1. Technical Field

The present disclosure relates to busbars.

### 2. Description of Related Art

Japanese Unexamined Patent Application Publication No. 2022-7032 (JP 2022-7032 A) discloses a technique in which slits (through holes) are formed in a busbar that connects terminals provided on the outer surfaces of battery cells arranged in a predetermined direction.

### SUMMARY

If the busbar is too rigid, it tends to separate from the terminals of the battery cells when the battery cells are displaced by an external force. If too many through holes are provided in the busbar, the busbar has reduced heat dissipation performance.

The disclosure disclosed in JP 2022-7032 A still has room for improvement in terms of suppressing an increase in the rigidity of the busbar while also suppressing an increase in the temperature of the busbar.

In view of the above, an object of the present disclosure is to provide a busbar capable of suppressing increases in both rigidity and temperature.

A busbar of a first aspect is a busbar having a plate shape and made of an electrically conductive material. The busbar is configured to be connected to terminals provided on one side in a perpendicular direction of two battery cells arranged in a predetermined direction, the perpendicular direction being perpendicular to both the predetermined direction and an up-down direction. The busbar includes: a first connection portion configured to be connected to the terminal of one of the two battery cells; a second connection portion configured to be connected to the terminal of the other of the two battery cells; and a first through hole and a second through hole that are provided in a region between the first connection portion and the second connection portion and are arranged in the up-down direction. A recessed portion recessed toward the opposite side from the second through hole is provided at an edge of the first through hole that is on the second through hole side.

The busbar of the first aspect is a busbar having a plate shape and configured to be connected to the terminals provided on one side in the perpendicular direction of the two battery cells arranged in the predetermined direction. The first connection portion of the busbar is configured to be connected to the terminal of one of the adjacent two battery cells, and the second connection portion is configured to be connected to the terminal of the other of the adjacent two battery cells. The busbar has the first through hole and the second through hole that are provided in the region between the first connection portion and the second connection portion and are arranged in the up-down direction.

Since the busbar of the first aspect has the first through hole and the second through hole, an increase in rigidity is suppressed.

In the busbar of the first aspect, the recessed portion recessed toward the opposite side from the second through hole is provided at the edge of the first through hole that is on the second through hole side. Therefore, the width (up-down dimension) of the region between the first connection portion and the second connection portion (electrical conduction path) and the size of the heat dissipation area are increased by the amount corresponding to the recessed portion. Accordingly, the electrical resistance in the electrical conduction path is reduced and the heat dissipation is improved by the amount corresponding to the recessed portion. As a result, the busbar is less likely to become high in temperature.

According to a busbar of a second aspect, in the first aspect, the width of the first through hole in the up-down direction is greater than the width of the second through hole in the up-down direction.

In the busbar of the second aspect, the width of the region between the first connection portion and the second connection portion (electrical conduction path) and the size of the heat dissipation area can be increased compared to a case where a recessed portion is provided at an edge of the second through hole that is on the first through hole side.

According to a busbar of a third aspect, in the first or second aspect, the busbar further includes: a first plate portion including the first connection portion; a second plate portion including the second connection portion and located in the same plane as the first plate portion; a pair of rising walls each extending away from the battery cells in the perpendicular direction from a corresponding one of opposing edges of the first plate portion and the second plate portion; and a central plate portion connecting opposing edges of the rising walls. The first through hole is provided so as to extend in the first plate portion, the second plate portion, the rising walls, and the central plate portion. The recessed portion is provided in the central plate portion.

In the bus bar of the third aspect, the rigidity of a connection portion between the first plate portion and the corresponding rising wall and a connection portion between the second plate portion and the corresponding rising wall tends to be high. However, the first through hole has a greater width in the up-down direction in these connection portions than in the portion where the recessed portion is provided. This configuration can reduce the rigidity of these connection portions compared to a case where a recessed portion is provided in these connection portions. Moreover, in the busbar of the third aspect, the recessed portion is provided in the central plate portion. A portion where a recessed portion is provided is less likely to be reduced in rigidity by the first through hole. However, the central plate portion has lower rigidity than these connection portions. Therefore, although the recessed portion is provided in the central plate portion, the rigidity of the central plate portion is less likely to be increased.

According to a busbar of a fourth aspect, in the first or second aspect, at least part of a portion of the first through hole where the recessed portion is provided is located above or below a region between a straight line connecting an upper end of the first connection portion and an upper end of the second connection portion and a straight line connecting a lower end of the first connection portion and a lower end of the second connection portion.

Current readily flows through the region between the straight line connecting the upper ends of the first connection portion and the second connection portion and the straight line connecting the lower ends of the first connection portion and the second connection portion. In the busbar of the fourth aspect, at least part of the portion of the first through hole where the recessed portion is provided is located above or below this region. Accordingly, there is little likelihood that the first through hole will cause an increase in the electrical resistance of the busbar.

As described above, the busbar according to the present disclosure is excellent in that it can suppress increases in both rigidity and temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a portion of a battery module including busbars according to an embodiment, as viewed from the left side;

FIG. 2 is a perspective view of a portion of the battery module, as viewed from the right side;

FIG. 3 is an exploded perspective view of a busbar and two battery cells; and

FIG. 4 is a side view of a busbar and two battery cells.

### DETAILED DESCRIPTION OF EMBODIMENTS

A battery module 10 provided with a busbar according to an embodiment will now be described with reference to the accompanying drawings. Arrows UP, FR, LH in the drawings indicate the upper side in the vehicle up-down direction, the front side in the vehicle front-rear direction (predetermined direction), and the left side in the vehicle left-right direction (perpendicular direction), respectively.

The battery module 10 of the present embodiment is mounted on a vehicle via a case (not shown). The vehicle of the present embodiment is a battery electric vehicle.

The case of the present embodiment houses at least one battery module 10. The electric power of the battery module 10 is supplied to, for example, an electric motor (not shown) that applies driving force to the drive wheels of the vehicle.

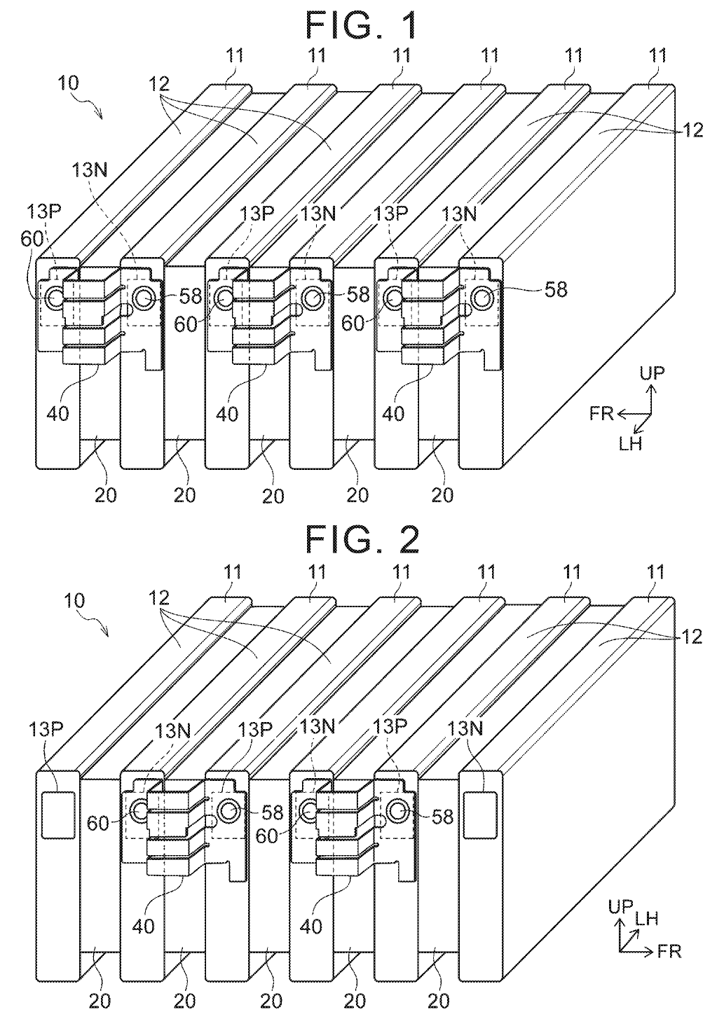

As shown in FIG. 1, the battery module 10 includes: a plurality of battery cells 11 that is lithium-ion secondary cells; a plurality of separators 20 that is insulating members each positioned between corresponding adjacent battery cells 11; a plurality of busbars 40; and a restraining member.

Each battery cell 11 has a metal cell case 12 in the form of a rectangular parallelepiped. The cell case 12 has a rectangular shape with its left-right dimension greater than its up-down dimension when viewed from the front. As shown in FIGS. 1 and 2, a positive terminal (terminal) 13P is provided on one of the right and left end faces of each cell case 12, and a negative terminal (terminal) 13N is provided on the other of the right and left end faces of each cell case 12. The positive terminal 13P and the negative terminal 13N are made of metal. In the present embodiment, as shown in FIGS. 1 and 2, the battery cells 11 are oriented in the left-right direction such that the positive terminals 13P and the negative terminals 13N of the battery cells 11 are alternately arranged in the front-rear direction.

Each separator 20 is a member that is made of resin and in the form of a substantially rectangular parallelepiped. Each separator 20 is positioned between a corresponding pair of battery cells 11.

The battery cells 11 and the separators 20 are restrained by the restraining member (not shown). Accordingly, each separator 20 and its adjacent battery cells 11 are in contact with each other.

Next, the busbars 40 made of metal will be described. The busbars 40 are made of, for example, a highly electrically conductive metal material such as copper.

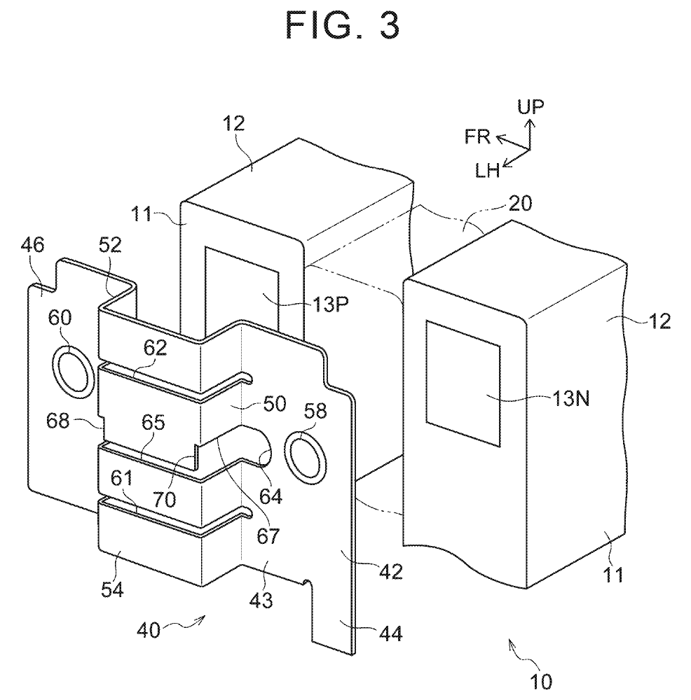

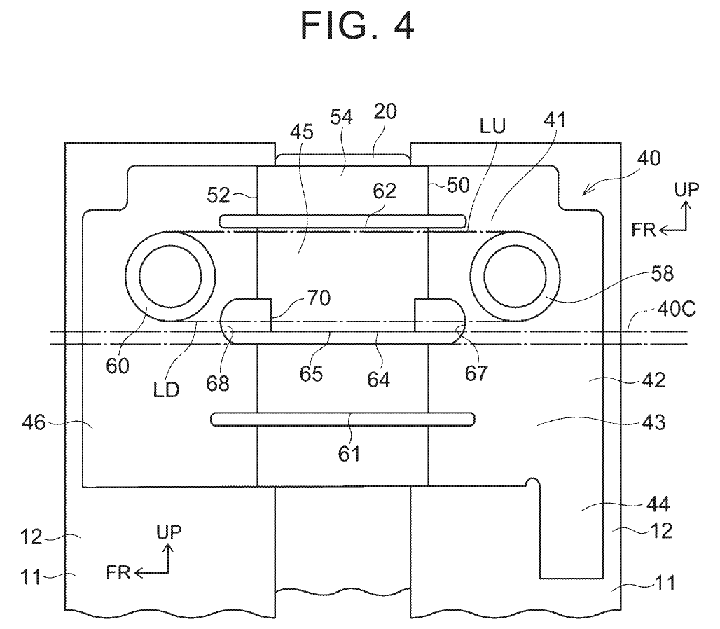

As shown in FIGS. 3 and 4, the busbar 40 is an integrally formed component including a first plate portion 42, a second plate portion 46, a first rising wall (rising wall) 50, a second rising wall (rising wall) 52, and a central plate portion 54. The busbar 40 of the present embodiment is manufactured by, for example, press-forming a metal plate.

The first plate portion 42 and the second plate portion 46 are portions in the form of a flat plate. The first plate portion 42 includes a body portion 43 having a substantially rectangular shape when viewed from the side, and a lower extension portion 44 extending downward from the body portion 43. The upper edge of the first plate portion 42 and the upper edge of the second plate portion 46 are substantially at the same position in the up-down direction. When the busbar 40 is in a free state, the first plate portion 42 and the second plate portion 46 are located substantially in the same plane.

The first rising wall 50 and the second rising wall 52 are respectively connected to the opposing edges of the body portion 43 and the second plate portion 46. Each of the first rising wall 50 and the second rising wall 52 has a substantially rectangular shape with its up-down dimension greater than its left-right dimension when viewed from the front. One edge of the first rising wall 50 in the left-right direction is connected to an edge of the body portion 43, and one edge of the second rising wall 52 in the left-right direction is connected to an edge of the second plate portion 46. When the busbar 40 is in a free state, the first rising wall 50 and the second rising wall 52 are substantially perpendicular to the first plate portion 42 and the second plate portion 46.

The front and rear edges of the central plate portion 54 are connected to the opposing edges of the second rising wall 52 and the first rising wall 50 that are opposite from the second plate portion 46 and the body portion 43, respectively. The central plate portion 54 has a substantially rectangular shape with its left-right dimension greater than its up-down dimension when viewed from the side. When the busbar 40 is in a free state, the central plate portion 54 is substantially perpendicular to the first rising wall 50 and the second rising wall 52, and is substantially parallel to the first plate portion 42 and the second plate portion 46.

A first welded portion (first connection portion) 58 is provided on the body portion 43 of the first plate portion 42, and a second welded portion (second connection portion) 60 is provided on the second plate portion 46. The first welded portion 58 and the second welded portion 60 have substantially the same shape. Specifically, each of the first welded portion 58 and the second welded portion 60 has a substantially circular shape when viewed from the side, with a through hole formed in its center. The first welded portion 58 and the second welded portion 60 are counterbored so as to have a thickness smaller than that of other regions of the body portion 43 and the second plate portion 46. As shown in FIG. 4, the first welded portion 58 and the second welded portion 60 are positioned above the central position 40C of the body portion 43 and the second plate portion 46 in the up-down direction. As shown in FIG. 4, in the busbar 40, the region between a straight line LU connecting the upper end of the first welded portion 58 and the upper end of the second welded portion 60 and a straight line LD connecting the lower end of the first welded portion 58 and the lower end of the second welded portion 60 is referred to as main electrical conduction region 45.

A slit 61 extending linearly in the front-rear direction when viewed from the side is formed in the portion located below the central position 40C of the body portion 43, the first rising wall 50, the central plate portion 54, the second rising wall 52, and the second plate portion 46. The width (up-down dimension) of the slit 61 is herein defined as first width W1.

A slit (second through hole) 62 extending linearly in the front-rear direction when viewed from the side is formed in the portion located above the main electrical conduction region 45 of the body portion 43, the first rising wall 50, the central plate portion 54, the second rising wall 52, and the second plate portion 46. The slit 62 has substantially the same shape as that of the slit 61 when viewed from the side. That is, the width of the slit 62 is the first width W1.

A slit (first through hole) 64 is formed in the central portion of the body portion 43, the first rising wall 50, the central plate portion 54, the second rising wall 52, and the second plate portion 46 in the front-rear direction. The front-rear dimension of the slit 64 is approximately the same as that of the slits 61, 62. The slit 64 includes a narrow portion 65 that is a portion formed in the central plate portion 54, a first wide portion 67 located on the first plate portion 42 side of the narrow portion 65 and connected to the narrow portion 65, and a second wide portion 68 located on the second plate portion 46 side of the narrow portion 65 and connected to the narrow portion 65. A second width W2, namely the width (up-down dimension) of the first wide portion 67 and the second wide portion 68, is larger than the width of the narrow portion 65 and the first width W1. In other words, a recessed portion 70 is provided along the edge on the slit 62 side of the portion of the slit 64 where the narrow portion 65 is formed.

As shown in FIGS. 1 and 2, each busbar 40 is welded to a positive terminal 13P and a negative terminal 13N provided on either the left or right side surfaces of two adjacent battery cells 11. Each of the first welded portions 58 of the busbars 40 provided on the left side of the battery cells 11 is welded to the negative terminal 13N of the corresponding battery cell 11 using a laser beam emitted from a welding device (not shown) located to the left of the busbars 40. In addition, each of the second welded portions 60 of these busbars 40 is welded to the positive terminal 13P of the corresponding battery cell 11 using a laser beam emitted from the welding device. Each of the first welded portions 58 of the busbars 40 provided on the right side of the battery cells 11 is welded to the positive terminal 13P of the corresponding battery cell 11 using a laser beam emitted from a welding device located to the right of the busbars 40. In addition, each of the second welded portions 60 of these busbars 40 is welded to the negative terminal 13N of the corresponding battery cell 11 using a laser beam emitted from the welding device. That is, in the battery module 10 of the present embodiment, the battery cells 11 are connected in series by the busbars 40.

Once the busbars 40 are welded to the positive terminals 13P and negative terminals 13N of the battery cells 11 in this manner, the battery module 10 is completed. The battery module 10 thus assembled is housed in a case, and the case is fixed to the vehicle body.

### Functions and Effects

Next, the operations and effects of the embodiment will be described.

When current flows between the positive terminal 13P and the negative terminal 13N connected by the busbar 40, the current flows through a region of the busbar 40 between the first welded portion 58 and the second welded portion 60. Hereinafter, the region of the busbar 40 through which the current flows will be referred to as electrical conduction path 41. The electrical conduction path 41 is a region larger than the main electrical conduction region 45. That is, current may flow through a region above the main electrical conduction region 45 of the busbar 40 or through a region below the main electrical conduction region 45 of the busbar 40. The main electrical conduction region 45 is a region where current flows particularly readily among the electrical conduction path 41.

Each busbar 40 of the present embodiment is a plate-shaped member connected to the positive terminal 13P and the negative terminal 13N provided on one side in the left-right direction (perpendicular direction) of corresponding adjacent two of the battery cells 11 arranged in the front-rear direction. The first welded portion 58 of each busbar 40 is connected to the terminal (one of the positive terminal 13P and the negative terminal 13N) of one of the adjacent two battery cells 11, and the second welded portion 60 is connected to the terminal (the other of the positive terminal 13P and the negative terminal 13N) of the other of the adjacent two battery cells 11. Each busbar 40 has the slits 62, 64 provided in the electrical conduction path 41 and arranged in the up-down direction.

As described above, each busbar 40 has the slits 61, 62, 64. Accordingly, the mechanical strength (rigidity) of the busbar 40 is reduced by the amount corresponding to the slits 61, 62, 64. Furthermore, the slit 64 includes the first and second wide portions 67, 68 having the second width W2 larger than the first width W1 of the slits 61, 62. The slits 61, 62, 64 suppresses an increase in rigidity of the busbar 40. Therefore, for example, when an external force in the up-down direction is applied from the battery cells 11 to the busbars 40 due to vibration during travel of the vehicle, or when each battery cell 11 expands and contracts, the busbars 40 can flexibly deform to absorb the external force. This configuration reduces the likelihood that the first welded portion 58 and the second welded portion 60 of each busbar 40 will separate from the corresponding positive terminal 13P or negative terminal 13N in such a case.

In addition, in each busbar 40, the recessed portion 70 recessed toward the opposite side from the slit 62 is provided at the edge of the slit 64 that is on the slit 62 side. Therefore, the width (up-down dimension) of the electrical conduction path 41 (main electrical conduction region 45) and the size of the heat dissipation area of the busbar 40 are increased by the amount corresponding to the recessed portion 70. Accordingly, the electrical resistance in the electrical conduction path 41 of the busbar 40 is reduced and the heat dissipation of the busbar 40 is improved by the amount corresponding to the recessed portion 70. As a result, the busbars 40 are less likely to become high in temperature. In addition, current can readily flow between the first welded portion 58 and the second welded portion 60 of each busbar 40.

If a recessed portion is provided at the edge of the slit 62 that is on the slit 64 side, the width of the recessed portion in the up-down direction will be smaller than the width of the recessed portion 70 in the up-down direction. That is, in this case, the amount of electrical resistance reduced by the recessed portion will be smaller than that of electrical resistance reduced by the recessed portion 70. Moreover, the heat dissipation area of the busbar 40 will be smaller than when the recessed portion 70 is formed. In other words, according to the busbar 40 of the present embodiment, the electrical resistance in the electrical conduction path 41 of the busbar 40 is more easily reduced and the heat dissipation performance of the busbar 40 is more easily improved, compared to the case where a recessed portion is provided at the edge of the slit 62 that is on the slit 64 side.

Furthermore, in the busbar 40, the mechanical strength (rigidity) of the connection portion between the first plate portion 42 and the first rising wall 50, the connection portion between the second plate portion 46 and the second rising wall 52, the connection portion between the first rising wall 50 and the central plate portion 54, and the connection portion between the second rising wall 52 and the central plate portion 54 tends to be higher compared to other portions. However, the first wide portion 67 and the second wide portion 68, namely the portions having a larger with in the up-down direction than the narrow portion 65 of the slit 64, are formed in these connection portions. This configuration can reduce the rigidity of these connection portions compared to a case where a recessed portion is provided in these connection portions.

Furthermore, the recessed portion 70 is provided in the central plate portion 54 of the busbar 40. A portion of the busbar 40 where a recessed portion is provided is less likely to be reduced in rigidity by the slit 64. However, the central plate portion 54 has lower rigidity than the connection portions. Therefore, although the recessed portion 70 is provided in the central plate portion 54, the rigidity of the central plate portion 54 is less likely to be increased.

As described above, the main electrical conduction region 45 is a region where current flows particularly readily among the electrical conduction path 41. In the busbar 40, the narrow portion 65, namely the portion of the slit 64 along which the recessed portion 70 is provided, is located below the main electrical conduction region 45. Therefore, compared to a case where the slit 64 has the second width W2 in the up-down direction along the entire length in the longitudinal direction of the slit 64, an increase in the electrical resistance of the electrical conduction path 41 of the busbar 40 or a reduction in the heat dissipation performance of the busbar 40 is less likely to be caused by the slit 64.

Although the busbar according to the embodiment has been described above, various design modifications can be made as appropriate without departing from the spirit and scope of the present disclosure.

For example, the slit 64 may be formed in the portion where the slit 62 is formed in the embodiment, and the slit 62 may be formed in the portion where the slit 64 is formed in the embodiment. In this case, the recessed portion 70 is provided at the lower edge of the slit 64. Moreover, in this case, the slit 62 is located below the main electrical conduction region 45, and the narrow portion 65 is located above the main electrical conduction region 45.

The slit 61 may be omitted from the busbar 40. In addition to the slits 61, 62, 64, a slit extending in the front-rear direction from the body portion 43 across the first rising wall 50, the central plate portion 54, and the second rising wall 52 into the second plate portion 46 may be formed in the busbar 40.

The vehicle may be an electrified vehicle equipped with an electric motor that uses the power of the battery module, rather than a battery electric vehicle. For example, the vehicle may be a hybrid electric vehicle or a plug-in hybrid electric vehicle.

What is claimed is:

1. A busbar having a plate shape and made of an electrically conductive material, the busbar being configured to be connected to terminals provided on one side in a perpendicular direction of two battery cells arranged in a predetermined direction, the perpendicular direction being perpendicular to both the predetermined direction and an up-down direction, the busbar comprising:
a first connection portion configured to be connected to the terminal of one of the two battery cells;
a second connection portion configured to be connected to the terminal of the other of the two battery cells; and
a first through hole and a second through hole that are provided in a region between the first connection portion and the second connection portion and are arranged in the up-down direction,
wherein a recessed portion recessed toward an opposite side from the second through hole is provided at an edge of the first through hole that is on the second through hole side.

2. The busbar according to claim 1, wherein a width of the first through hole in the up-down direction is greater than a width of the second through hole in the up-down direction.

3. The busbar according to claim 1, further comprising:
a first plate portion including the first connection portion;
a second plate portion including the second connection portion and located in the same plane as the first plate portion;
a pair of rising walls each extending away from the battery cells in the perpendicular direction from a corresponding one of opposing edges of the first plate portion and the second plate portion; and
a central plate portion connecting opposing edges of the rising walls, wherein:
the first through hole is provided so as to extend in the first plate portion, the second plate portion, the rising walls, and the central plate portion; and
the recessed portion is provided in the central plate portion.

4. The busbar according to claim 1, wherein at least part of a portion of the first through hole where the recessed portion is provided is located above or below a region between a straight line connecting an upper end of the first connection portion and an upper end of the second connection portion and a straight line connecting a lower end of the first connection portion and a lower end of the second connection portion.
